(19) United States
(12) Patent Application Publication
(10) Pub. No.: US 2014/0320505 A1
(43) Pub. Date: Oct. 30, 2014

(54) GREYSCALE ANIMATION

(71) Applicant: KOBO INCORPORATED, Toronto (CA)

(72) Inventor: Paul McDougall, Toronto (CA)

(73) Assignee: Kobo Incorporated, Toronto (CA)

(21) Appl. No.: 13/874,341

(22) Filed: Apr. 30, 2013

(51) Int. Cl. G06T 13/80

(52) U.S. Cl. CPC G06T 13/80
USPC 345/473

(57) ABSTRACT

Greyscale animation. In accordance with a first method embodiment, an animation region of an electronic display is determined. The animation region is set to display a flash-mitigating background color pattern. An animation sequence is displayed in the animation region. The flash-mitigating background color pattern may include a checkerboard pattern of alternating grey colored picture elements.

### FIELD OF INVENTION

Embodiments of the present invention relate to the field of electronic displays. More specifically, embodiments of the present invention relate to systems and methods for greyscale animation.

### BACKGROUND

Electronic paper, e-paper and electronic ink are display technologies that are designed to mimic the appearance of ink on paper. Such displays generally comprise vast arrays of small spherical particles that are dark or black on one side, and light or white on another side. For example, an electric and/or magnetic field controls the orientation of each particle such that a desired side is facing forward, producing a desired image. A related display technology moves small particles within a dye; a relative position of a particle to a display surface determines whether a particular picture element is dark or light. Such displays offer attractive advantages of high contrast and low power, and have found wide acceptance in “e-reader” devices, watches and other electronic devices.

Unfortunately, at least some of these displays are challenged to display animation, e.g., “moving” images, in greyscale, e.g., shades other than the darkest possible and the lightest possible display elements. For example, some displays, or display technologies, require that a change from a black picture element to a grey picture element must first, at least briefly, include a white picture element. Deleteriously, such a black-to-grey-via-white transition causes a visually undesirable “flash,” and has essentially prevented widespread greyscale animation on such displays under the conventional art.

### SUMMARY OF THE INVENTION

Therefore, what is needed are systems and methods for greyscale animation that avoid undesirable visual artifacts. What is additionally needed are systems and methods for greyscale animation for electronic ink type display panels that avoid particular color transitions. A further need exists for systems and methods for greyscale animation that are compatible and complementary with existing systems and methods of electronic display operation and programming. Embodiments of the present invention provide these advantages.

In accordance with a first method embodiment, an animation region of an electronic display is determined. The animation region is set to display a flash-mitigating background color pattern. An animation sequence is displayed in the animation region. The flash-mitigating background color pattern may include a checkerboard pattern of alternating grey colored picture elements. The animation may take place on an electronic ink type display panel.

In accordance with another embodiment of the present invention, a computer system includes a processor and a display device coupled to the processor. The display device is capable of displaying white, black and at least one intermediate level of grey. The computer system is configured to display greyscale animation by displaying a black and white animation against a flash-mitigating background color pattern. The display device may be an electronic ink type display.

In accordance with a further embodiment of the present invention, an article of manufacture includes a computer readable media having instructions stored thereon that, responsive to execution by a computing device, cause the computing device to determine an animation region of an electronic display and set the animation region to display a flash-mitigating background color pattern. The computing device displays an animation sequence in the animation region. The display device may be an electronic ink type display.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1 is a block diagram of an exemplary computer system, which may be used as a platform to implement embodiments of the present invention.

FIG. 2 illustrates an exemplary group of picture elements, in accordance with embodiments of the present invention.

FIG. 3A illustrates an exemplary greyscale animation, in accordance with embodiments of the present invention.

FIG. 3B illustrates another exemplary greyscale animation sequence, in accordance with embodiments of the present invention.

FIG. 4 illustrates a method of forming a greyscale animation on an electronic display, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### Notation and Nomenclature

Some portions of the detailed descriptions which follow (e.g., method 400) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining” or “setting” or “displaying” or “accessing” or “placing” or “testing” or “forming” or “mounting” or “removing” or “coating” or “attaching” or “processing” or “performing” or “generating” or “adjusting” or “creating” or “executing” or “continuing” or “indexing” or “computing” or “translating” or “calculating” or “determining” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As used herein, the term “picture element” or “pixel” is used to refer to or to describe the smallest portion of an electronic display that may be discriminated, e.g., directly addressed and/or controlled. For example, for a display described as having a resolution of 256 dots per inch (DPI), there are 256 pixels per inch.

As used herein, the term “light colored pixel” is used to refer to or to describe a picture element that transfers a relatively greater amount of light to a viewer's eye, e.g., either via reflection or transmission. The term “white colored pixel” is used to refer to or to describe a picture element that transfers the most light to a viewer's eye. The term “dark colored pixel” is used to refer to or to describe a picture element that transfers a relatively lesser amount of light to a viewer's eye. The term “black colored pixel” is used to refer to or to describe a picture element that transfers the least or no light to a viewer's eye. The term “grey colored pixel” is used to refer to or to describe a picture element that transfers an intermediate amount of light to a viewer's eye, e.g., an amount between maximum and minimum amounts of light.

Reviewer question—will it work without using absolutely black or absolutely white?

As used herein, the term “cell” is used to refer to or to describe a group of picture elements. A cell may be any suitable size and/or shape.

### Greyscale Animation

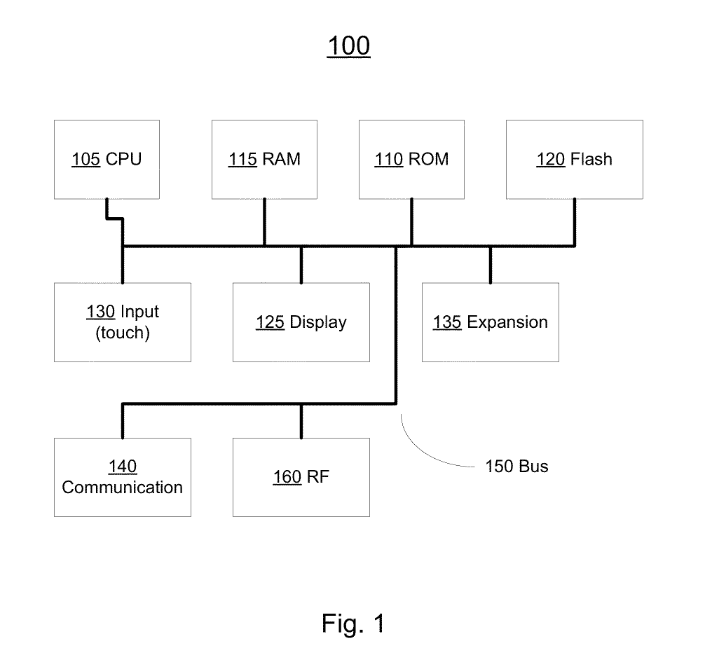

FIG. 1 is a block diagram of an exemplary computer system 100, which may be used as a platform to implement embodiments of the present invention. Computer system 100 may be battery-powered, in some embodiments. Computer system 100 includes an address/data bus 150 for communicating information, a central processor 105 functionally coupled with the bus for processing information and instructions. Central processor 105 may comprise multiple processors, e.g., a multi-core processor, or multiple separate processors, in some embodiments. Computer system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Computer system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in computer system 100 of FIG. 1 is an optional input device 130. Device 130 can communicate information and command selections to the central processor 100. Input device 130 may take the form of buttons and/or a touch sensitive digitizer panel, e.g., capacitive or resistive touch panels.

The display unit 125 utilized with the computer system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments.

Computer system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In one embodiment of the present invention, expansion interface 135 may consist of signals substantially compliant with the signals of bus 150.

A wide variety of well known devices may be attached to computer system 100 via the bus 150 and/or expansion interface 135. Examples of such devices include without limitation rotating magnetic memory devices, flash memory devices, digital cameras, wireless communication modules, digital audio players and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140 or via expansion interface 135.

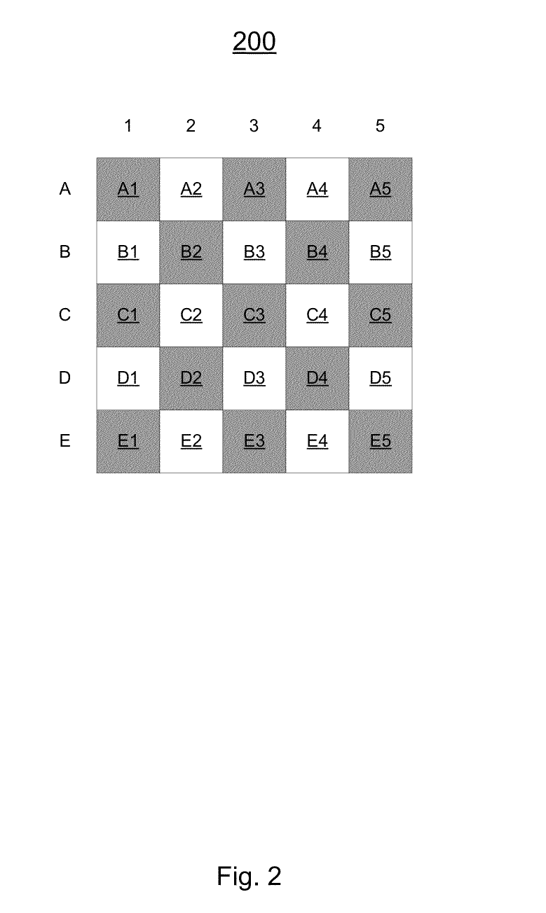

FIG. 2 illustrates an exemplary group of picture elements 200, in accordance with embodiments of the present invention. As illustrated, group 200 comprises 25 picture elements of an electronic display, e.g., an electronic ink display, disposed in an array of five rows (labeled A through E) and five columns (labeled 1 through 5). It is appreciated that a typical display will comprise many more picture elements (not shown) than illustrated. Accordingly, FIG. 2 illustrates an exemplary portion of an electronic display. However, it is to be appreciated that a group of picture elements may be any size, shape and number of picture elements, in accordance with embodiments of the present invention. Further, although the individual picture elements are illustrated as substantially square, embodiments in accordance with the present invention are well suited to other pixel shapes, including non-square rectangular pixels and oval pixels.

In accordance with embodiments of the present invention, approximately one half of the picture elements, e.g., pixels A2, B3, D5, etc., are white colored pixels, while the remaining picture elements, e.g., pixels A1, B2, C3, etc. are grey colored pixels, e.g., at a level between black and white. Any suitable shade of grey may be used. For example, pixels A1, B2, C3 are illustrated as approximately 50% black, e.g., a level about one half between black colored pixels and white colored pixels.

It is appreciated that a white colored pixel, e.g., a picture element which transfers the most light to a viewer's eye, is not required, in accordance with embodiments of the present invention. For example, a “less dark” colored pixel may be substituted for any or all of the illustrated white colored picture elements. The “white colored” pixels should be lighter than the grey colored pixels, which in turn should be lighter than “dark” or “black” colored pixels.

It is to be further appreciated that embodiments in accordance with the present invention are presented with particular exemplary colors, e.g., “white” and “grey” colored pixels. These particular colors may correspond to a “paper-like” display, e.g., black or grey images on a white background. It is appreciated however, that if a “light on dark” image is desired, dark colored pixels may be substituted for light colored pixels herein. All such embodiments are to be considered within the scope of the present invention.

The white colored pixels and grey colored pixels of group 200 are arranged in a checkerboard pattern. For example, white colored pixels are diagonally adjacent to other white colored pixels, and grey colored pixels are diagonally adjacent to other grey colored pixels. Further, white colored pixels are horizontally and vertically adjacent to grey colored pixels, and vice versa.

Overall, a human visual system will perceive group 200 as a “light” grey shade. As will be further described below, group 200 forms a region of flash-mitigating background color pattern.

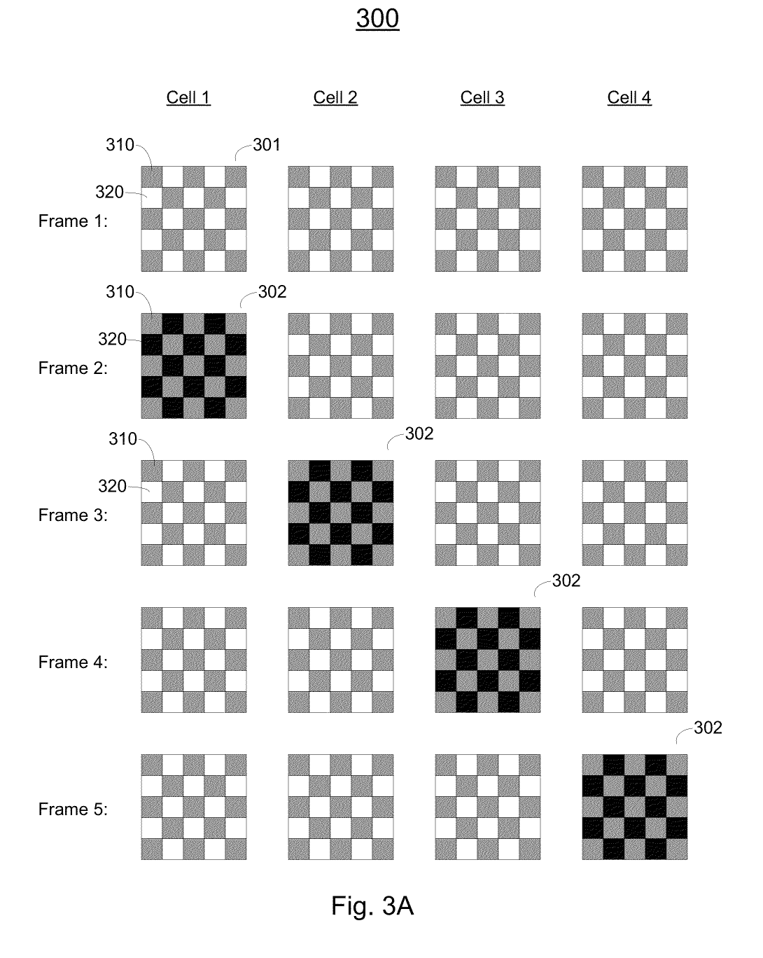

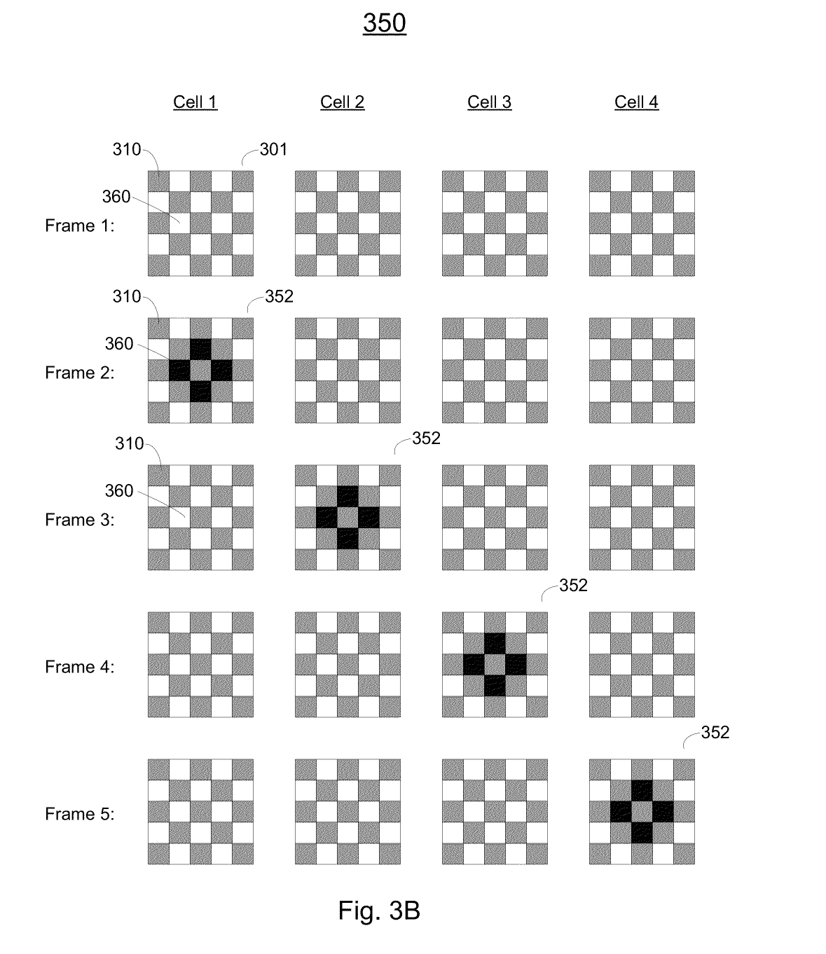

FIG. 3A illustrates an exemplary greyscale animation sequence 300, in accordance with embodiments of the present invention. Animation sequence 300 illustrates four “cells” horizontally. In the present example, the cells (labeled 1 through 4) are horizontally adjacent on a display, although that is not required. The gaps horizontally between the cells are added for clarity; typically, they may not be present.

Further with respect to FIG. 3A, animation sequence 300 illustrates a time duration of five frames in the downward vertical dimension, e.g., from frame 1 (earlier) to frame 5 (later). Each frame represents a change in an animation sequence. It is to be appreciated that the illustrated frame rate is exemplary and does not necessarily correspond to a display refresh rate, although it may.

Animation sequence 300 illustrates an animation cell 302 moving across a display area comprising cells 1 through 4 over time. Animation cell 302 may be a portion of a larger figure or shape. For example, an entire animated figure or shape may be larger than the illustrated 25 picture elements, and may include cells above, below, to the left and/or to the right of the illustrated cells. In frame 1, all cells are set to a flash-mitigating background color pattern 301, e.g., as illustrated in group 200 of FIG. 2.

In frame 2, an exemplary animation pattern 302 is introduced into the image, at cell 1. Exemplary animation pattern 302 comprises dark or black picture elements in place of the light or white colored picture elements of flash-mitigating background color pattern 301. A human visual system will perceive exemplary animation pattern 302 as a dark grey. It is appreciated that the grey or “middle level” color cells of exemplary animation pattern 302 have not changed from their pattern or location in flash-mitigating background color pattern 301. It is further appreciated that all white colored picture elements do not need to change to black colored picture elements. The black colored picture elements are determined by the characteristics of the animation.

In frame 3, the exemplary animation pattern 302 is located in cell 2, and cell 1 has reverted to flash-mitigating background color pattern 301. Similarly, in frames 4 and 5, the exemplary animation pattern 302 is located in cells 3 and 4, respectively, and the remaining cells display flash-mitigating background color pattern 301. In this novel manner, a dark grey animation pattern is perceived to move across a light grey background.

It is to be appreciated that no grey picture elements change color in this sequence. For example, grey picture element 310 in the upper left of cell 1 during frame 1 is still grey in frame 2, and remains grey throughout the illustrated animation sequence. Moreover, no picture element changes to grey. For example, the light or white picture element 320 below the upper left picture element of cell 1 during frame 1 changes to dark or black at frame 2, and back to light or white at frame 3.

FIG. 3B illustrates another exemplary greyscale animation sequence 350, in accordance with embodiments of the present invention. Animation sequence 300 illustrates four “cells” horizontally. In the present example, the cells (labeled 1 through 4) are horizontally adjacent on a display, although that is not required. The gaps horizontally between the cells are added for clarity; typically, they may not be present.

Further with respect to FIG. 3B, animation sequence 350 illustrates a time duration of five frames in the downward vertical dimension, e.g., from frame 1 (earlier) to frame 5 (later). Each frame represents a change in an animation sequence. It is to be appreciated that the illustrated frame rate is exemplary and does not necessarily correspond to a display refresh rate, although it may.

Animation sequence 350 illustrates an animation cell 352 moving across a display area comprising cells 1 through 4 over time. Animation cell 352 is smaller than the background cell size, e.g., comprising 4 black “dots” or picture elements in a “diamond” shape. In frame 1, all cells are set to a flash-mitigating background color pattern 301, e.g., as illustrated in group 200 of FIG. 2.

In frame 2, an exemplary animation pattern 352 is introduced into the image, at cell 1. Exemplary animation pattern 352 comprises dark or black picture elements in place of the light or white colored picture elements of flash-mitigating background color pattern 301. A human visual system will perceive exemplary animation pattern 352 as a dark grey. It is appreciated that the grey or “middle level” color cells of exemplary animation pattern 352 have not changed from their pattern or location in flash-mitigating background color pattern 301. It is further appreciated that all white colored picture elements do not need to change to black colored picture elements. The black colored picture elements are determined by the characteristics of the animation.

In frame 3, the exemplary animation pattern 352 is located in cell 2, and cell 1 has reverted to flash-mitigating background color pattern 301. Similarly, in frames 4 and 5, the exemplary animation pattern 352 is located in cells 3 and 4, respectively, and the remaining cells display flash-mitigating background color pattern 301. In this novel manner, a dark grey animation pattern is perceived to move across a light grey background.

It is to be appreciated that no grey picture elements change color in this sequence. For example, grey picture element 310 in the upper left of cell 1 during frame 1 is still grey in frame 2, and remains grey throughout the illustrated animation sequence. Moreover, no picture element changes to grey. For example, the light or white picture element 360 of cell 1 during frame 1 changes to dark or black at frame 2, and back to light or white at frame 3.

In this novel manner, transitions from grey to another color, and transitions from another color to grey are not required and are avoided during greyscale animation. More particularly, the deleterious flash of white effect that is sometimes present in black to grey transitions is advantageously avoided. Further, since unchanging picture elements may require less power to display than picture elements that change, embodiments in accordance with the present invention may also have beneficially decreased power requirements.

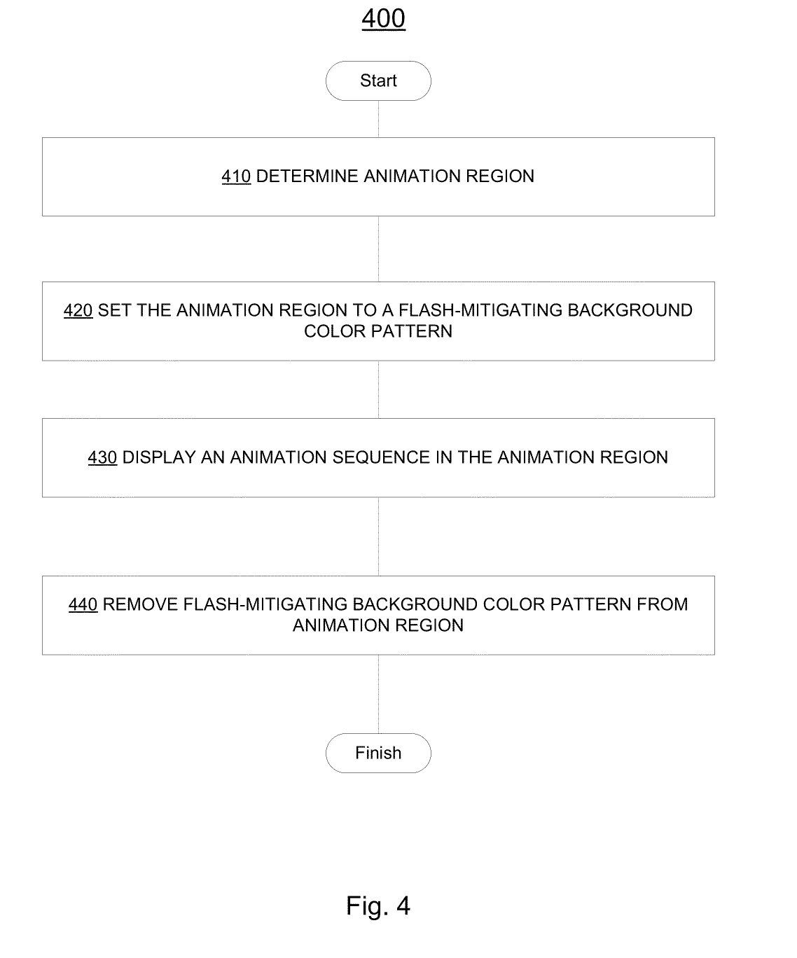

FIG. 4 illustrates a method 400 of forming a greyscale animation on an electronic display, in accordance with embodiments of the present invention. In 410, an animation region for an animation is determined. In 420, the animation region is set to a flash-mitigating background color pattern.

In 430, an animation sequence is displayed in the animation region. The grey colored picture elements of the flash-mitigating background color pattern in the animation region are not changed during the animation.

In optional 440, the flash-mitigating background color pattern is removed from the animation region after the animation is complete. In this novel manner, a greyscale animation may be presented on an electronic display, e.g., an electronic ink display.

Embodiments in accordance with the present invention provide systems and methods for greyscale animation. In addition, embodiments in accordance with the present invention provide systems and methods for greyscale animation that avoid particular color transitions. Further, embodiments in accordance with the present invention provide systems and methods for greyscale animation that are compatible and complementary with existing systems and methods of electronic display operation and programming.

Various embodiments of the invention are thus described. While the present invention has been described in particular embodiments, it should be appreciated that the invention should not be construed as limited by such embodiments, but rather construed according to the below claims.

What is claimed is:

1. A method comprising:
determining an animation region of an electronic display;
setting said animation region to display a flash-mitigating background color pattern; and
displaying an animation sequence in said animation region.

2. The method of claim 1 wherein said flash-mitigating background color pattern comprises a checkerboard pattern comprising alternating grey colored picture elements.

3. The method of claim 2 wherein said checkerboard pattern further comprises white colored picture elements that alternate with said grey colored picture elements.

4. The method of claim 2 wherein said checkerboard pattern further comprises black colored picture elements that alternate with said grey colored picture elements.

5. The method of claim 1 wherein said electronic display comprises an electronic ink type display.

6. The method of claim 5 wherein said electronic display is characterized in that an animation transition to or from a grey colored picture element from or to a black or white colored picture element is constrained by said electronic display to require an intermediate transition to an undesired color.

7. The method of claim 1 wherein said displaying comprises changing only black or white colored picture elements to the other of white or black colored picture elements.

8. A computer system comprising:
a processor;
a display device, coupled to said processor, capable of displaying white, black and at least one intermediate level of grey;
logic configured to control and display greyscale animation by displaying a black and white animation against a flash-mitigating background color pattern.

9. The system of claim 8 wherein said flash-mitigating background color pattern comprises a checkerboard pattern comprising grey colored picture elements alternating with white colored picture elements.

10. The system of claim 8 wherein said flash-mitigating background color pattern comprises a checkerboard pattern comprising grey colored picture elements alternating with white colored picture elements.

11. The system of claim 8 wherein said electronic display comprises an electronic paper type display.

12. The system of claim 11 wherein said electronic display is characterized and requiring display of a white colored picture element in order to change a black colored picture element to a grey colored picture element.

13. The system of claim 8 wherein said logic is further configured to display said greyscale animation without changing a grey colored picture element of said flash-mitigating background color pattern.

14. An article of manufacture comprising a computer readable media having instructions stored thereon that, responsive to execution by a computing device, cause said computing device to perform operations comprising:
determining an animation region of an electronic display;
setting said animation region to display a flash-mitigating background color pattern; and
displaying an animation sequence in said animation region.

15. The article of manufacture of claim 1 wherein said flash-mitigating background color pattern comprises a checkerboard pattern comprising alternating grey colored picture elements.

16. The article of manufacture of claim 2 wherein said checkerboard pattern further comprises white colored picture elements that alternate with said grey colored picture elements.

17. The article of manufacture of claim 2 wherein said checkerboard pattern further comprises black colored picture elements that alternate with said grey colored picture elements.

18. The article of manufacture of claim 1 wherein said electronic display comprises an electronic ink display.

19. The article of manufacture of claim 5 wherein said electronic display is characterized in that an animation transition to or from a grey colored picture element from or to a black or white colored picture element is constrained by said electronic display to require an intermediate transition to an undesired color.

20. The article of manufacture of claim 1 wherein said displaying comprises changing only black or white colored picture elements to the other of white or black colored picture elements.
